(19) United States
(12) Patent Application Publication
(10) Pub. No.: US 2002/0110178 A1
(43) Pub. Date: Aug. 15, 2002

(54) Infrared temperature sensor

(75) Inventors: Christopher M. Puranen, Noblesville, IN (US); Ronald P. Jones, Russiaville, IN (US); Phillip B. Sprecher, Noblesville, IN (US)

Correspondence Address: STEFAN V. CHMIELEWSKI, DELPHI TECHNOLOGIES, INC., Legal Staff Mail Code CT10C, P.O. Box 9005, Kokomo, IN, 46904-9005, US

(73) Assignee: DELPHI TECHNOLOGIES, INC.

(21) Appl. No.: 10/125,946

(22) Filed: Apr. 19, 2002

Related U.S. Application Data
(62) Division of application No. 09/571,441, filed on May 15, 2000.

(51) Int. Cl. G01J 5/02; G01K 1/14; G01K 13/00

(52) U.S. Cl. 374/121; 374/141

(57) ABSTRACT

In one aspect of the invention, a temperature sensing system, including: control components; and an infrared sensor to provide a temperature input signal to the control components, the infrared sensor being located remotely from the control components. In an additional aspect of the invention, a circuit board for an infrared temperature sensing system, including: a first portion; a second portion coplanar with the first portion; and at least one necked down portion joining the first portion and the second portion. In a further aspect of the invention, a housing for an infrared temperature sensing system, including: a base member; and first support members attached to the base member to permit an infrared temperature sensor to be mounted in a selected one of two positions.

### BACKGROUND OF THE INVENTION

1. Field of the Invention

The present invention relates to temperature sensing systems generally and, more particularly, to a novel infrared temperature sensor.

2. Background Art

While the present invention is described primarily with respect to climate control in a vehicle, it will be understood that it may be applied in any situation in which it is desired to measure the temperature of a surface. For example, the present invention may be employed in an intrusion sensing system in a vehicle or in other than a vehicle.

Heating, ventilating, and air conditioning (HVAC) systems for vehicles have developed such that they require rather sophisticated control systems. Such control systems often require inputs of various combinations of passenger compartment air temperature, the temperature of surfaces in the passenger compartment, outside air temperature, controlled air temperature, rate of solar radiation, battery capacity, and/or engine coolant temperature. The inputs of interest are combined in an algorithm in a microprocessor that outputs control signals to other components of the HVAC system.

As part of such systems, the temperature of passenger compartment surfaces is typically measured by a sensor comprising one or two infrared detectors with compensation provided by one or more thermistors. The sensor provides an output signal representative of the temperature of the surface or surfaces within view of the infrared detectors.

The following patents illustrate the use of sensing devices of the type that may be employed in the present invention:

U.S. Pat. No. 5,400,964, issued Mar. 28, 1995, to Freidberger, titled INFRA-RED COMFORT SENSOR, and assigned to the assignee of the present invention, describes a climate control system for the interior of a vehicle and includes infrared sensing to measure thermal level therein and to provide a signal to the system control for establishing and maintaining the thermal level of the interior of the vehicle to a level preset by a vehicle occupant. The viewing field and admissibility of the infra-red sensor determine the composition of the signal by controlling the objects, surfaces, area, and radiation included in the field. Appropriate selection of the viewing field and the admissibility integrates into signal corrective factors for external climatic conditions and solar re-radiation within the vehicle.

U.S. Pat. No. 5,518,176, issued May 21, 1996, to Turner et al., titled AUTOMOTIVE CLIMATE CONTROL WITH INFRA-RED SENSING, and assigned to the assignee of the present invention, describes an air temperature sensor for sensing the temperature of air within the passenger compartment of the vehicle and producing an air temperature signal and an infrared sensor for viewing a predetermined portion of the passenger compartment and producing a thermal level signal. Control means are responsive to the thermal level signal and the air temperature signal to control an HVAC system, wherein air flow is determined as a function of the linear combination of the thermal level signal and the air temperature signal, independently of the time rate of change of the thermal level. In one embodiment, the control system also receives inputs of outside air temperature and battery voltage and the vehicle is ventilated when idle, provided that sufficient battery capacity exists.

U.S. Pat. No. 5,531,377, issued Jul. 2, 1996, to Thayer et al., titled METHOD AND APPARATUS FOR CALIBRATION OF COMFORT CONTROL IR SENSOR, and assigned to the assignee of the present invention, describes an infrared sensor for determining the temperature of a vehicle interior, the sensor including a thermistor and a thermopile in a can and a protective window that exposes the thermopile to the thermal energy of the interior of the vehicle. The combined outputs of these thermally sensitive elements represents the interior radiant temperature. The effectiveness of the thermopile changes if the window becomes dirty, changing the output of the thermopile. A resistive heater on the can is used to heat the sensor during calibration. A microprocessor receiving the outputs of the sensor has an algorithm for adjusting a gain that compensates for sensor changes. When the interior compartment of the vehicle is stable, the sensor is heated and thermistor values before and after heating the sensor are used as a basis for adjustment of the gain.

One problem with control systems that employ sensors of the above type, that is, sensors that must view an object the surface temperature of which is to be measured, is that the sensors are located in proximity to the HVAC controls. These controls, due to space and other mechanical considerations, are usually located low in the vehicle, typically in the lower region of the dashboard of the vehicle. This means that the view of the sensor is necessarily limited to the legs of the occupant(s) of the passenger compartment of the vehicle and/or to the fronts of the front seats in the vehicle. This, in turn, means that the surface temperatures of these items are what are input to the temperature controls. This arrangement is frequently undesirable, in that, for example, the temperature of the surfaces of the legs of an occupant will depend on whether or not the occupant is wearing clothing on the occupant's legs and the nature of that clothing.

That temperature, as well as the surface temperature of the fronts of the front seats can vary greatly and may have little relationship to actual or desired surface temperatures of, for example, the more temperature-sensitive upper torso of the occupant.

It is desirable, therefore, that the surface temperature sensor be located higher in the vehicle and remote from the other components of the HVAC system and that the sensor output an amplified signal representative of the temperature of the surface in view of the sensor.

Accordingly, it is a principal object of the present invention to provide a surface temperature sensor for a vehicle HVAC control system that is located remotely from the other components of the HVAC control system.

It is a further object of the present invention to provide such a surface temperature sensor for a vehicle HVAC control system that outputs an amplified signal representative of the temperature of the surface in view of the sensor.

It is an additional object of the present invention to provide such a surface temperature sensor for a vehicle HVAC control system that is compactly and economically packaged and easily installed.

It is another object of the present invention to provide such a surface temperature sensor that can be used in two different configurations for economy in manufacturing.

Other objects of the present invention, as well as particular features, elements, and advantages thereof, will be elucidated in, or be apparent from, the following description and the accompanying drawing figures.

### SUMMARY OF THE INVENTION

The present invention achieves the above objects, among others, by providing, in one aspect of the invention, a temperature sensing system, comprising: control components; and an infrared sensor to provide a temperature input signal to said control components, the infrared sensor being located remotely from said control components. In an additional aspect of the invention, a circuit board for an infrared temperature sensing system, comprising: a first portion; a second portion coplanar with said first portion; and at least one necked down portion joining said first portion and said second portion. In a further aspect of the invention, a housing for an infrared temperature sensing system, comprising: a base member; and first support members attached to said base member to permit an infrared temperature sensor to be mounted in a selected one of two positions.

### BRIEF DESCRIPTION OF THE DRAWING

Understanding of the present invention and the various aspects thereof will be facilitated by reference to the accompanying drawing figures, provided for purposes of illustration only and not intended to define the scope of the invention, on which:

FIG. 1 is a fragmentary, front elevational view of a vehicle dashboard with a conventional climate control arrangement.

FIG. 2 is a fragmentary front elevational view of a vehicle dashboard with a climate control according to the present invention.

FIG. 3 is a block diagram of the control system in which the present invention is employed.

FIG. 4A-4E comprise a schematic diagram of the control system of FIG. 3.

FIG. 5 is a front plan view of circuit board for use in the present invention during a stage of manufacture thereof.

FIG. 6 is an exploded isometric view of the sensor assembly of the present invention.

FIG. 7 is a top plan view of one arrangement of the sensor assembly.

FIG. 8 is a top plan view of another arrangement of the sensor assembly.

### DETAILED DESCRIPTION OF THE PREFERRED EMBODIMENTS

Reference should now be made to the drawing figures on which similar or identical elements are given consistent identifying numerals throughout the various figures thereof, and on which parenthetical references to figure numbers direct the reader to the view(s) on which the element(s) being described is (are) best seen, although the element(s) may be seen on other figures also.

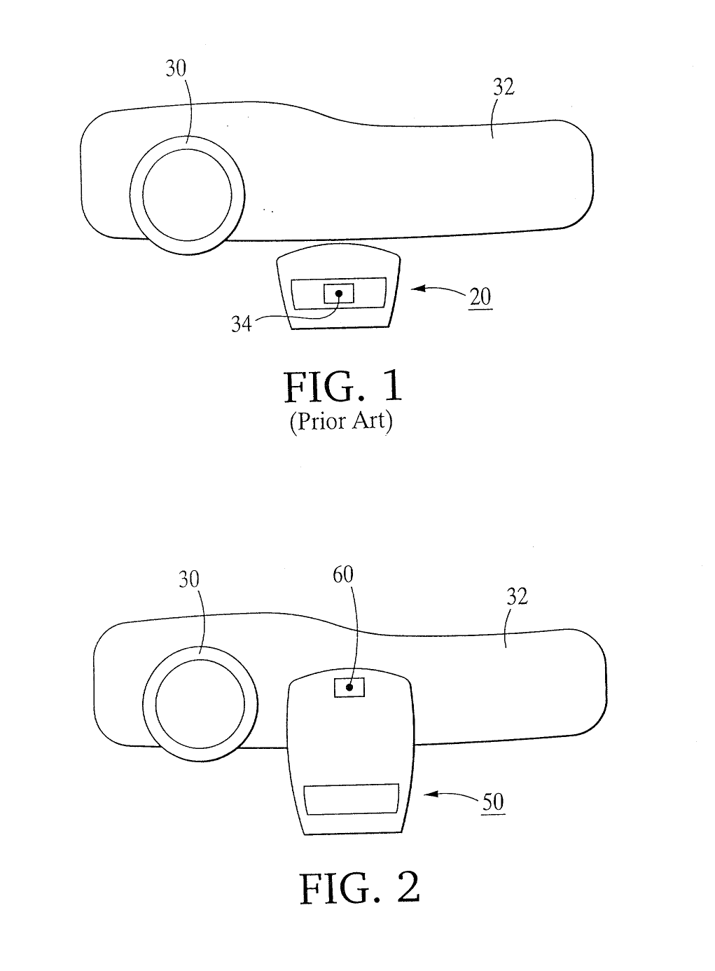

FIG. 1 illustrates a conventional climate control arrangement for a vehicle, the climate control being generally indicated by the reference numeral 20. Climate control 20 is shown as being mounted below the steering wheel 30 and the dashboard 32 of the vehicle (not otherwise shown) and includes a temperature sensor 34 mounted in the climate control. Temperature sensor 34 typically includes at least one infrared sensor. As noted above, this location for climate control 20 causes temperature sensor assembly 34 to sense the temperature of the legs of the occupants of the vehicle and/or the temperature of the front of the seat(s) of the vehicle. Thus, the temperature sensed by temperature sensor 34 as an input to climate control 20 is not necessarily that which will provide the greatest comfort for the occupant(s) of the vehicle.

FIG. 2 illustrates a climate control, according to the present invention, and generally indicated by the reference numeral 50 mounted in a vehicle having steering wheel 30 and dashboard 32 (the vehicle being not otherwise shown). Climate control 50 includes a temperature sensor assembly 60 that is mounted so that the view of the sensor more nearly encompasses the torso(s) of occupant(s) of the vehicle. In this position, the temperature sensed by temperature sensor assembly 60 is the temperature more likely that which is to be controlled to provide the greatest comfort to the occupant(s). This arrangement leaves the bulk of climate control 50 low in the vehicle, but moves the sensor upwards for a more appropriate view of the occupant(s) of the vehicle.

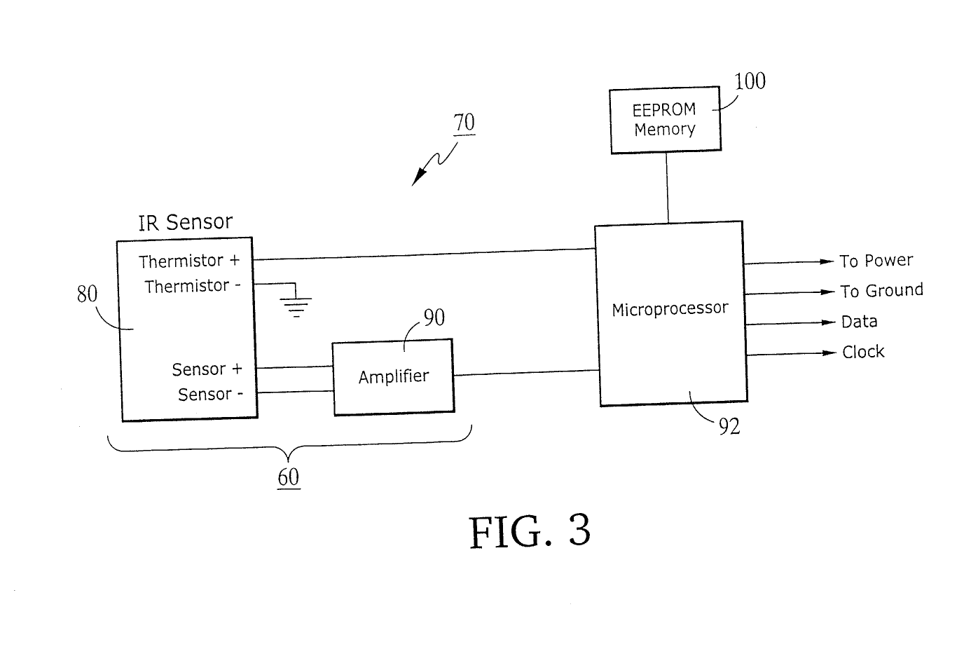

FIG. 3 is a block diagram of the control circuitry for the present invention, the control circuitry being generally indicated by the reference numeral 70. Control circuitry 70 includes temperature sensor assembly 60 having therein an infrared sensor 80 that measures the infrared radiation from all surfaces in direct view of the sensor. Infrared sensor 80 is of the type described above and consists of a two silicon infrared thermopiles with thermistors thermally connected to the bases of the infrared thermopiles. The thermistor provides a temperature of the thermopile and the thermopile provides a voltage that represents the difference in temperature between itself and the surface at which it is pointed. An amplifier 90 in temperature sensor assembly 60 raises the voltage produced by the thermopiles to a level that can be measured by a microprocessor 92 using an analog-to-digital input port. Microprocessor 92 measures both the thermistor and amplified thermopile voltages, performs calculations to derive surface temperature, and then transmits this temperature over a two-wire serial communication bus. This temperature information can then be received by a separate module to perform various applications such as climate control or intrusion sensing. An EEPROM memory 100 associated with microprocessor 92 includes therein calibration values for temperature sensor assembly 60. These calibration values are derived from measuring known temperature targets and storing the results in EEPROM memory 100.

The small size and the communications ability of temperature sensor assembly 60 allow placement of the temperature sensor assembly virtually anywhere in a vehicle or other than a vehicle remotely from other components of the system of which the temperature sensor assembly is a part.

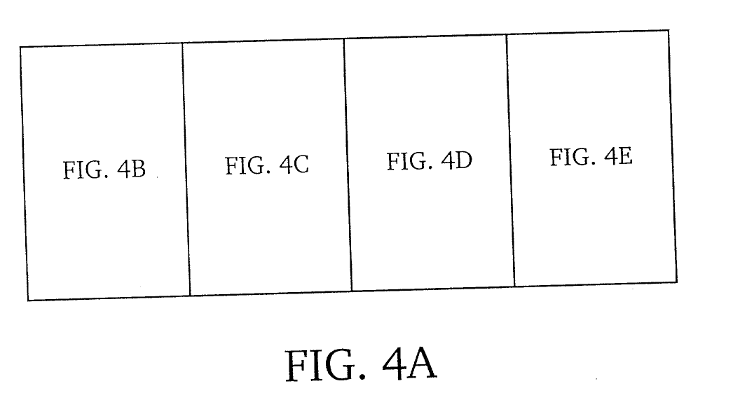

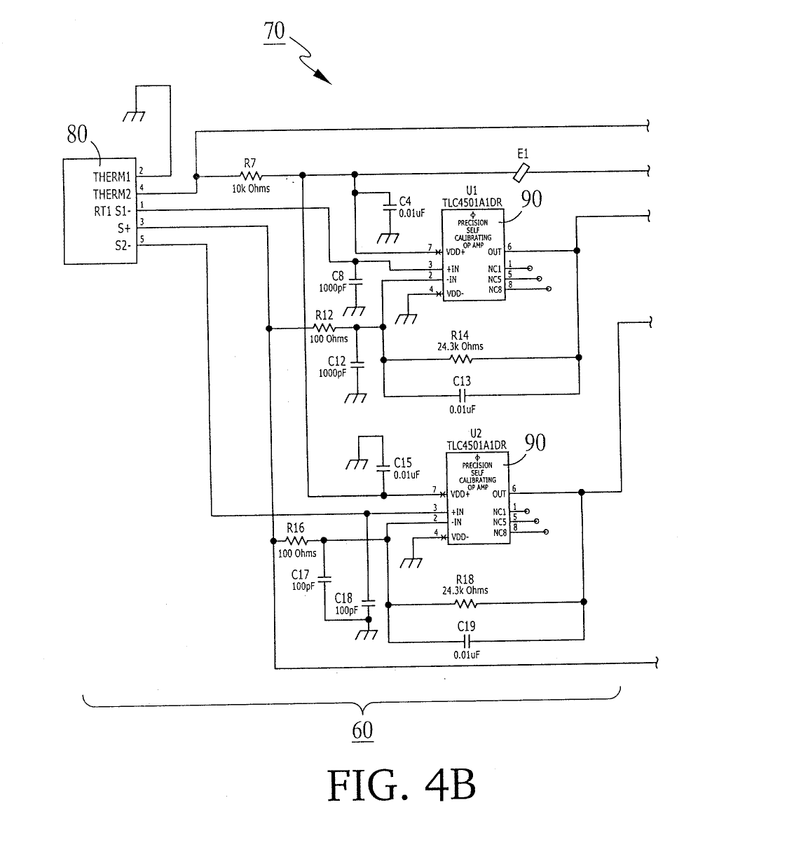

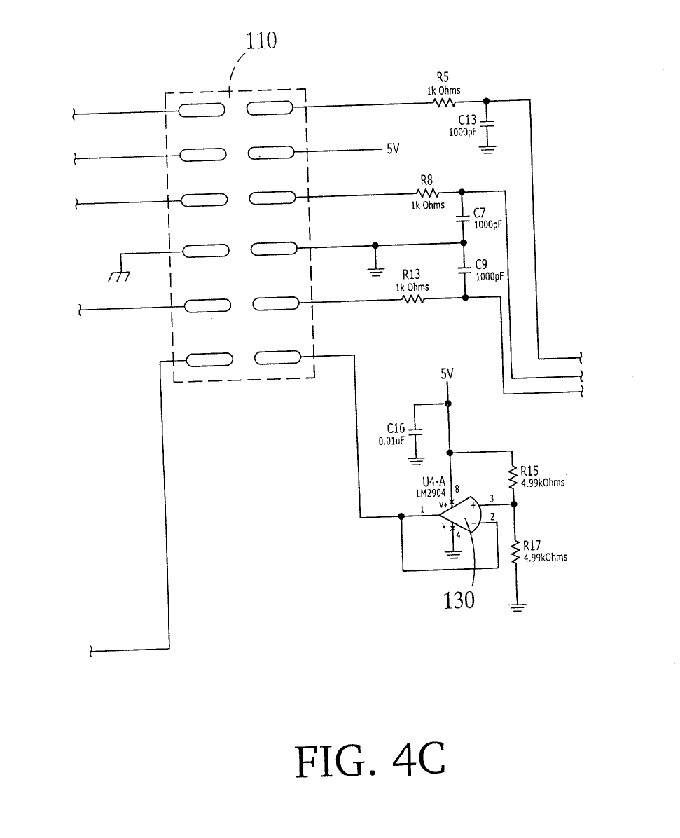

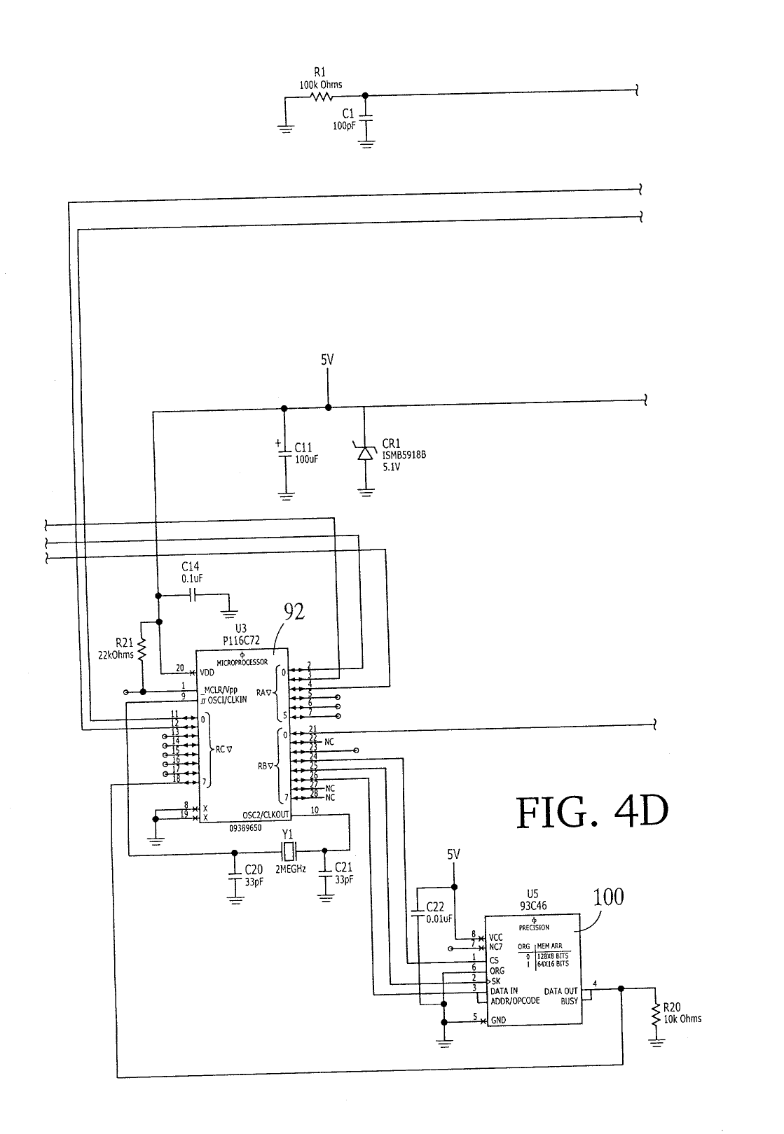

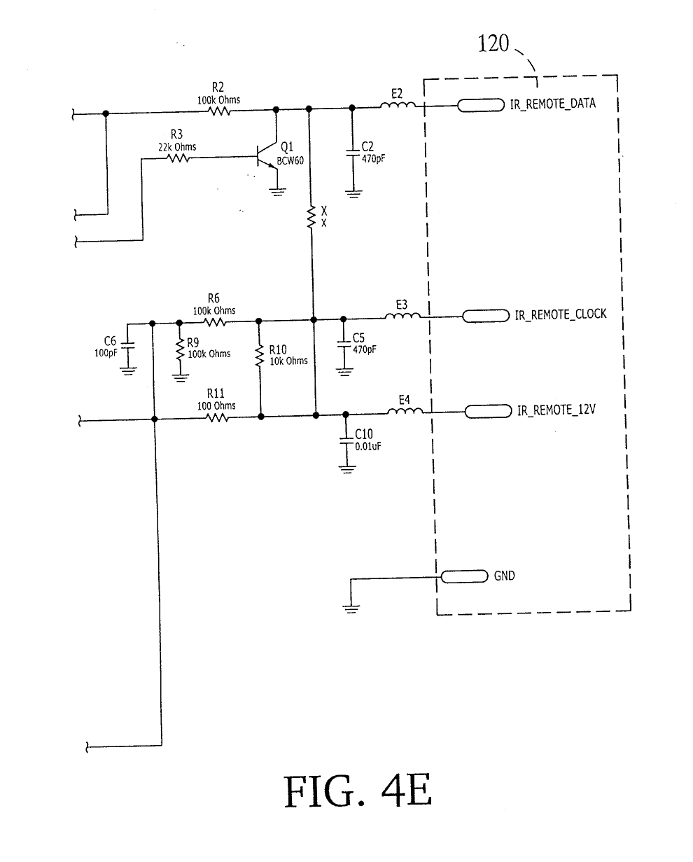

FIG. 4 illustrates control circuitry 70 in more detail. Infrared sensor 80 actually includes two infrared thermopiles and, for this reason, two amplifiers 90 are provided. Amplifiers 90 may be National Semiconductor Op Amp No. LMC 2001. A connector 110 connects the components of temperature sensor assembly 60 with the other components of the system. Microprocessor 92 may be No. PIC16C72 and offboard EEPROM 100 may have a one kilobyte capacity. An output connector 120 permits the connection of control circuitry 70 to other components of the system. A comparator 130 generates a 2-½-volt reference voltage required because the commons of the two infrared thermopiles in infrared sensor 80 are connected.

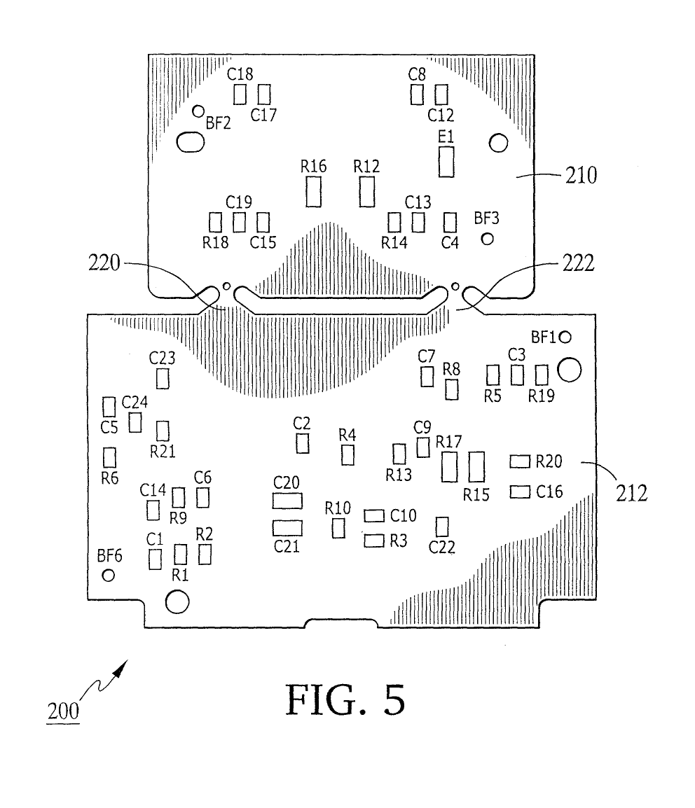

FIG. 5 illustrates a step in the manufacture of a circuit board for use in the present invention, the circuit board being generally indicated by the reference numeral 200. Circuit board 200 has an upper portion 210 and a lower portion 212, the upper and lower portions being coplanar and cojoined at two places by necked down portions 220 and 222. Upper portion 210 has mounted thereon components of temperature sensor assembly 60 (FIG. 4) and has disposed thereon conventional conductive traces for the interconnection of those components (conductive traces not shown). Likewise, lower portion 212 has mounted thereon the remaining components of control circuitry 70 (FIG. 4) and has disposed thereon conventional conductive traces for the interconnection of those components (conductive traces shown). Circuit board 200 is of conventional construction and has been die cut from stock material.

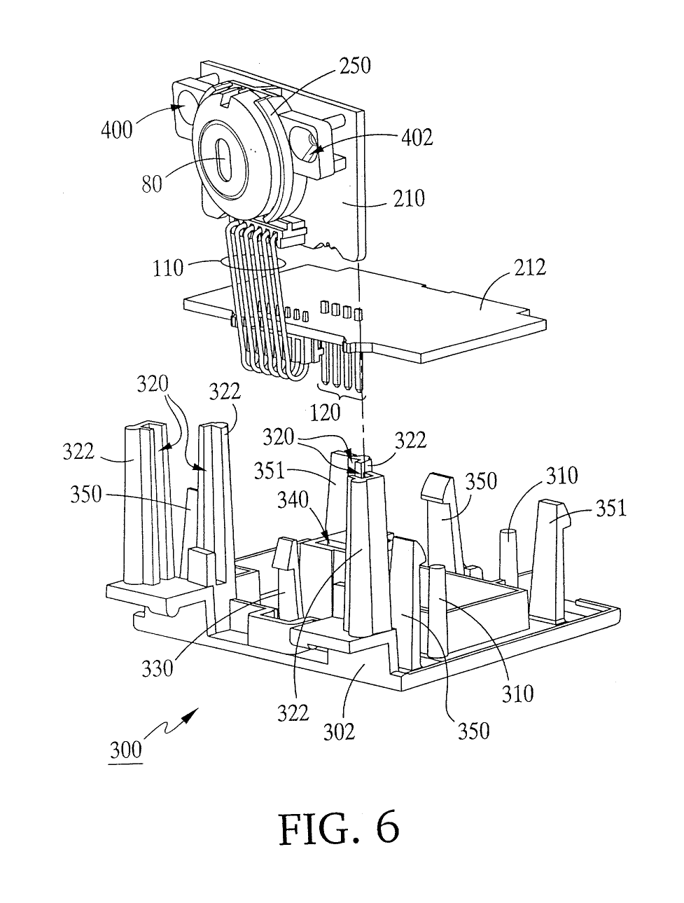

Referring now to FIG. 6, necked down portions 220 and 222 of circuit board 200 (FIG. 5) have been severed and upper and lower portions 210 and 212 of the circuit board are now disposed orthogonally to each other, with upper portion 210 being generally vertical, while lower portion 212 is generally horizontal. Infrared sensor 80 is shown mounted in a holder 250 fixedly attached to upper portion 210. The components (not shown on FIG. 6, except for infrared sensor 80) disposed on upper portion 210 are connected to the components (not shown on FIG. 6) on lower portion 212 by means of flexible connector 110. The components on lower portion 212 are connected to output connector 120.

Upper and lower portions 210 and 212 are shown disposed above a housing, generally indicated by the reference numeral 300, and having a generally horizontal base member 302. When assembled, lower portion 212 will be held to the tops of four vertical posts 310 (only two shown on FIG. 6) rising from base member 302 by means of three inwardly facing snap posts 350. Also when assembled, upper portion 210 will be inserted into an opposing pair of vertical slots 320 formed in four vertical guide posts 322 rising from the base member, as is described more fully below. Upper portion 210 is secured in place in vertical slots 320 by means of engagement with the rear of the upper portion of a vertical retaining post 330 rising from base member 302. Placement of lower portion 212 on the tops of vertical posts 310 causes the pins of connector 120 to be inserted into a receptacle 340 formed on base member 302. Other connector means (not shown) provide connection to other components of the system of which the present invention is a part. Two outwardly facing vertical snap posts 351 permit attachment of housing 300 to another component of the system of which the present invention is a part, such as a component of climate control 50 (FIG. 2).

A circular opening 400 defined in holder 250 serves as a four-way locator and a vertical slot 402 defined in the holder serves as a two-way locator, the locators accommodating therein horizontal locating pins (not shown) formed on a mating component (not shown). When housing 300 is being attached to the mating component, the locating pins enter circular opening 400 and vertical slot 402 to assure that that sensor 80 is centered within a viewing aperture defined in the mating component. Upper portion 210 is sized to permit side to side and up and down movement of the upper portion in vertical slots 320. This provides freedom for upper portion 210 to move side to side and up and down as the pins enter circular opening 400 and vertical slot 402, resulting in a reduced tolerance stack-up over that which would occur if the upper portion were located in a fixed position relative to housing 300.

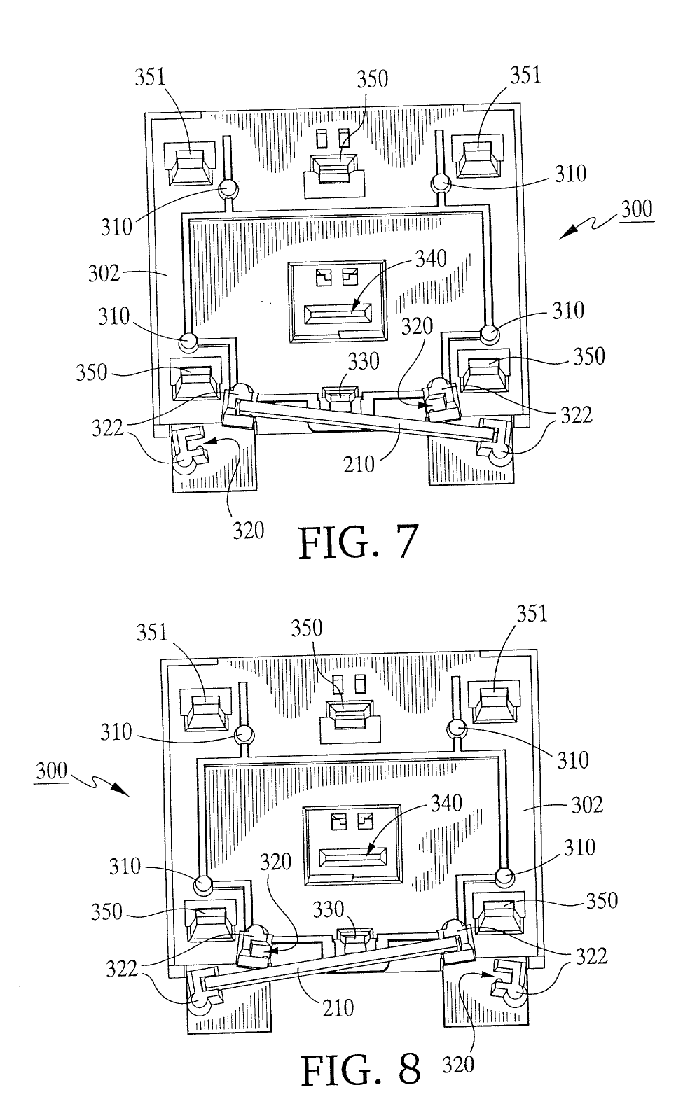

FIGS. 7 and 8 illustrate another important feature of the present invention. On those figures, lower portion 212, infrared sensor 80, holder 250, and connector 110 have been omitted for clarity. The arrangement of these components is shown on FIG. 6.

Referring first to FIG. 7, upper portion 210 has been inserted into an opposing pair of vertical slots 320 in vertical guide posts 322 such that the view of infrared sensor 80 (FIG. 6, not shown on FIG. 7) is generally towards the left of the center axis of housing 300. Referring now to FIG. 8, upper portion 210 has been inserted into the other opposing pair of vertical slots 320 in vertical guide posts 322 such that the view of infrared sensor 80 (FIG. 6, not shown on FIG. 8) is generally towards the right of the center axis of the center axis of housing 300. This arrangement permits the same components to be used for different mounting arrangements in different vehicles, while maintaining a desired view for infrared sensor 80.

In the embodiments of the present invention described above, it will be recognized that individual elements and/or features thereof are not necessarily limited to a particular embodiment but, where applicable, are interchangeable and can be used in any selected embodiment even though such may not be specifically shown.

Terms such as “upper”, “lower”, “inner”, “outer”, “inwardly”, “outwardly”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

The embodiments of the invention in which an exclusive property or privilege is claimed are defined as follows:

1. A temperature sensing system, comprising:
(a) control components; and
(b) an infrared sensor to provide a temperature input signal to said control components, said infrared sensor being located remotely from said control components.

2. A temperature sensing system, as defined in claim 1, wherein: said infrared sensor includes an amplifier to provide an amplified said temperature input signal to said control components.

3. A temperature sensing system, as defined in claim 1, wherein: said temperature sensing system is part of a heating, ventilating, and air conditioning system in a vehicle.

4. A temperature sensing system, as defined in claim 1, wherein: said temperature sensing system is part of an intrusion detection system in a vehicle.

5. A circuit board for an infrared temperature sensing system, comprising:
(a) a first portion;
(b) a second portion coplanar with said first portion; and
(c) at least one necked down portion joining said first portion and said second portion.

6. A circuit board for an infrared temperature sensing system, as defined in claim 5, wherein: said at least one necked down portion is severable such that said first portion and said second portion can be separately disposed.

7. A circuit board for an infrared temperature sensing system, as defined in claim 6, further comprising: means on each of said first portion and said second portion to accept a connector to electrically join components on said first portion and said second portion.

8. A circuit board for an infrared temperature sensing system, as defined in claim 5, wherein: said temperature sensing system is part of a heating, ventilating, and air conditioning system in a vehicle.

9. A circuit board for an infrared temperature sensing system, as defined in claim 5, wherein: said temperature sensing system is part of an intrusion detection system in a vehicle.

10. A housing for an infrared temperature sensing system, comprising:
(a) a base member; and
(b) first support members attached to said base member to permit an infrared temperature sensor to be mounted two said first support members in a selected one of two positions.

11. A housing for an infrared temperature sensing system, as defined in claim 10, wherein:
(a) said first support members comprise four posts;
(b) said temperature sensor is attached to a first circuit board; and
(c) when said first circuit board is attached to a first pair of opposing posts, said temperature sensor will have a view in a first direction, and, when said first circuit board is attached to a second pair of opposing posts, said temperature sensor will have a view in a second direction.

12. A housing for an infrared temperature sensing system, as defined in claim 10, further comprising: second supports and attachment means to permit a second circuit board to be mounted to said base member.

13. A housing for an infrared temperature sensing system, as defined in claim 12, wherein: said first circuit board is vertically mounted to said housing and said second circuit board is horizontally mounted to said housing immediately behind said first circuit board.

14. A housing for an infrared temperature sensing system, as defined in claim 10, wherein: said infrared temperature sensing system is part of a heating, ventilating, and air conditioning system in a vehicle.

15. A housing for an infrared temperature sensing system, as defined in claim 10, wherein: said infrared temperature sensing system is part of an intrusion detection system in a vehicle.

16. A housing for an infrared temperature sensing system, as defined in claim 11, wherein: said first circuit board is attached to said first or second pairs of opposing posts in a manner that permits freedom of movement of said first circuit board in said housing from side to side and up and down as said housing is attached to a mating component.
